(19) United States
(12) Patent Application Publication
(10) Pub. No.: US 2011/0119985 A1
(43) Pub. Date: May 26, 2011

(54) DOUBLE-BLADED FISHING LURE

(76) Inventor: John Siler, Peoria, AZ (US)

(21) Appl. No.: 12/623,959

(22) Filed: Nov. 23, 2009

(51) Int. Cl. A01K 85/10

(52) U.S. Cl. 43/42.2; 43/42.19

(57) ABSTRACT

A spinner lure for attracting fish comprising: an eyelet, where the eyelet suspends the contents of the spinner; a treble hook suspended at the opposite end of the eyelet; at least two blades suspended between the eyelet and treble hook; stirrups, where a stirrup is provided for each blade to attach the blade to the lure; and a plurality of beads, where said beads are dispersed between the blades and one bead is placed between the eyelet and the first blade, and one bead is placed between the treble hook and the last blade on the lure. The blades are capable of moving both clockwise and counterclockwise and create a propeller like movement when retrieved through the water.

### BACKGROUND OF THE INVENTION

1. Field of Invention

The present invention relates to an improved and unique fishing lure to attract fish.

2. Description of Related Art

Many fishermen instead of using live bait such as dead fish, worms, insects or likewise use synthetically manufactured fishing lures that attract fish. Lures are attached to a fishing line and reeled through water or cast into water in order to attract fish. The lures are designed to move about in the water either with the help of the water current or through the retraction of the fishing line through the water. The fishing lure uses movement, vibration and color in order to attract the fish's attention and may be equipped with one or more single, double or triple hooks that hook the fish that attack the lure. The lure may be attached to a fishing rod or a fishing reel assembly and therefore may be casted out continuously in order to attract and catch fish.

Fishing lures come in many sizes, colors, styles and patterns. Some of the fishing lures include gigs, spoons, plastic baits, plugs, and spinner baits. Numerous designs have been developed and various techniques are used with various types of lures. Fishermen are always seeking an advantage by switching or using different types of lures in particular situations. It is therefore always advantageous to have further development in the area of fishing lures so that fishermen can have an assortment of lures and also have various means to attract and catch fish.

### SUMMARY OF THE INVENTION

The present invention relates to a spinner lure for attracting fish comprising: an eyelet, where the eyelet suspends the contents of the spinner; a treble hook suspended at the opposite end of the eyelet; at least two blades suspended between the eyelet and treble hook; stirrups, where a stirrup is provided for each blade to attach the blade to the lure; and a plurality of beads, where said beads are dispersed between the blades and one bead is placed between the eyelet and the first blade, and one bead is placed between the treble hook and the last blade on the lure. The blades are capable of moving both clockwise and counterclockwise and create a propeller like movement when retrieved through the water.

### BRIEF DESCRIPTION OF DRAWINGS

FIG. 1 depicts a double-bladed fishing lure according to the present invention.

### DETAILED DESCRIPTION

The present invention relates to a double-bladed spinning fishing lure that provides an improved design upon the traditional fishing lure. The double-bladed spinning fishing lure according to the present invention that provides a means to attract a variety and a quantity of fish by utilizing colorful spinning blades in stirrups that provide substantially more vibration to the lure as it is being retrieved through the water.

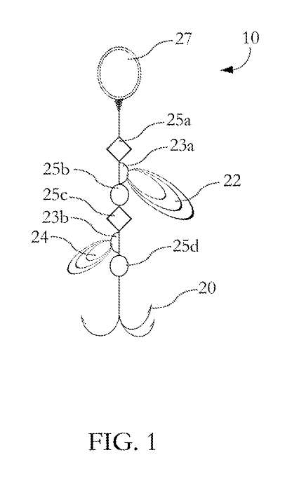

An exemplary embodiment of a double-bladed spinner 10 is depicted in FIG. 1. The double-bladed spinner 10 includes an eyelet 27 from which suspends the contents of the spinner 10. Suspended from the eyelet 27, include a treble hook 20 that is attached to the opposite end thereof. Between the eyelet 27 and treble hook 20 lies the contents of the spinner 10. A large blade 22 and a small blade 24 are suspended upon the spinner 10. The blades 22 and 24 are attached to the lure via stirrups 23a, 23b. Between the blades 22, 24 are positioned multiple beads 25a, 25b, 25c, 25d. The multiple beads are in between the blades 22, 24 and abut the blades 22, 24 at each end thereof. In this particular embodiment, the smaller blade 24 lies below the larger blade 22 and two beads 25b and 25c lie between the blades. Beads abut both outer ends of the blades 22, 24, where bead 25a is positioned above the larger blade 22 and 25d is positioned below the smaller blade 24.

Although, FIG. 1 depicts one embodiment of the spinner 10 that includes two blades 22, 24, it is contemplated by the present invention that additional blades may be added to the spinner 10 create another embodiment of the present invention. Beads may be used to separate the blades as shown in the embodiment depicted in FIG. 1.

The blades 22, 24 are colorful spinning blades and the stirrups themselves provide additional or more substantial vibration to the lure while it is being retrieved through the water. The blades 22, 24 are capable of moving both clockwise and counterclockwise to create optimum movement and flash while being retrieved through the water. The remarkable movement characteristics of the spinning lure 10 creates a higher likelihood of hooking and landing larger fish due to the increased flashing and vibration capabilities of the fishing lure 10. The spinning characteristics of the blades 22, 24 create a propeller-like movement where the blades 22, 24 move in both the clockwise and counterclockwise rotation and therefore may stimulate a colorful display to attract a fish's attention. Also the spinning lure 10 emits various colors and spinning rotations that are unique to each cast tossed into the water by the fisherman. The design of the fishing lure in accordance with the present invention increases the likelihood of attracting fish and also is far superior to the fishing lures of the prior art. The instant invention has been shown and described in what it considers to be the most practical and preferred embodiments. It is recognized, however, that departures may be made there from within the scope of the invention and that obvious modifications will occur to a person skilled in the art.

What is claimed is:

1. A spinner lure for attracting fish comprising:
a. an eyelet, where the eyelet suspends the contents of the spinner;
b. a treble hook suspended at the opposite end of the eyelet;
c. at least two blades suspended between the eyelet and treble hook;
d. stirrups, where a stirrup is provided for each blade to attach the blade to the lure; and
e. a plurality of beads, where said beads are dispersed between the blades and one bead is placed between the eyelet and the first blade, and one bead is placed between the treble hook and the last blade on the lure.

2. The spinner lure according to claim 1, where the blades are capable of moving both clockwise and counterclockwise.

3. The spinner lure according to claim 2, where the blades create a propeller like movement.

4. A spinner lure for attracting fish comprising:
a. an eyelet, where the eyelet suspends the contents of the spinner;
b. a treble hook suspended at the opposite end of the eyelet;
c. two blades suspended between the eyelet and treble hook;
d. stirrups, where a stirrup is provided for each blade to attach the blade to the lure; and
e. a plurality of beads, where said beads are dispersed between the blades and one bead is placed between the eyelet and the first blade, and one bead is placed between the treble hook and the last blade on the lure.

5. The spinner lure according to claim 4, where one blade is smaller than the other blade.

6. The spinner lure according to claim 5, where the blades are capable of moving both clockwise and counterclockwise.

7. The spinner lure according to claim 6, where the blades create a propeller like movement.
